(19) United States
(12) Patent Application Publication
(10) Pub. No.: US 2014/0202937 A1
(43) Pub. Date: Jul. 24, 2014

(54) WELDING INSPECTION DEVICE

(71) Applicants: Kenichi Ohtake, Kazo-City (JP); Jo Yagi, Kazo-City (JP)

(72) Inventors: Kenichi Ohtake, Kazo-City (JP); Jo Yagi, Kazo-City (JP)

(73) Assignee: F-TECH INC., Kuki-City, Saitama (JP)

(21) Appl. No.: 14/116,415

(22) PCT Filed: Jun. 6, 2012
(86) PCT No.: PCT/JP2012/064553

§ 371 Date: Nov. 8, 2013

(30) Foreign Application Priority Data
Jun. 7, 2011 (JP) 2011-127361

(51) Int. Cl. G01N 29/04; B07C 5/34

(52) U.S. Cl. CPC G01N 29/045; B07C 5/34
USPC 209/576

(57) ABSTRACT

An inspection unit of a welding inspection device includes: a striking device having a striking member that applies an impulsive force to a press molded article, a drive mechanism that applies a drive force to the striking member, and an urging member that urges the striking member; a microphone to which sound waves generated from the press molded article; and a detection device that detects a welding state of the press molded article. The striking member applies the impulsive force to the press molded article in a state in which the drive force by the drive mechanism is cut off and the striking member is urged by the urging member in the direction opposite to the application direction, and after application of the impulsive force to the press molded article, the striking member is forcibly pulled back in the direction opposite to the application direction by the urging member.

### TECHNICAL FIELD

The present invention relates to a welding inspection device, and more particularly relates to a welding inspection device that inspects a welding state of a strength component of a vehicle such as an automobile by using sound waves generated from the strength component.

### BACKGROUND ART

In recent years, an inspection device that inspects a bonding state of solder of electric components or the like and a welding state of a welding of mechanical components or the like in a non-destructive manner has been proposed.

Such a non-destructive inspection device includes an inspection device that uses sound waves or vibrations generated from an inspection target component by providing vibrations to the inspection target component, to perform non-destructive inspection for the bonding state of solder or the welding state of a welding.

Under such circumstances, Patent Document 1 discloses a configuration in which an acoustic transducer or a vibrator 7 is arranged at an end of a conductive wire 2 and an acoustic receiving device 8 is arranged at a base end of the conductive wire 2, to compare acoustic impedance in various frequencies with known acoustic impedance of a solder joint portion, thereby inspecting the inspecting target solder joint portion.

Patent Document 2 relates to a judgment device of a welding state with respect to a multipoint welded part and discloses a configuration including an impulse hammer 1 that excites an excitation point V of a door T of an automobile, a plurality of acceleration pickups 2 that detect. vibration of measure points M1 to M7, and a control analysis unit 5 including an excitation/vibration detecting unit 3A, an FFT processing unit 3B, a data storage. unit 3C, an OK/NG judgment unit 3D, and a display unit 4.

Patent Document 3 relates to an impulse hammer device that provides a certain impulsive force to a measurement target. FIGS. 3 and 4 discloses a configuration including a rigid hammer 1 arranged movably, a return spring 14 as an elastic movement restoring unit of the hammer 1, and a rotation drive spring 21 as an elastic drive unit that provides a traveling force to the hammer 1.

### PRIOR ART DOCUMENT

### Patent Documents

Patent Document 1 Japanese Unexamined Patent Application Publication (Translation of PCT Application) No. S56-501176

Patent Document 2: Japanese Patent Application Laid-open Publication No. H09-171007

Patent Document 3: Japanese Patent Application Laid-open Publication No. H10-185754

### SUMMARY OF THE INVENTION

### Problem to be Solved by the Invention

However, according to the studies performed by the present inventors, in the configuration of Patent Document 1, although the configuration for inspecting the inspection target solder joint portion by comparing the inspection target acoustic impedance with the predetermined acoustic impedance is disclosed, there is no specific disclosure or suggestion for inspecting the welding state of a strength component of a vehicle such as an automobile.

In Patent Document 2, although the configuration of judging the welding state of the multipoint welded portion in an automobile door is disclosed, a plurality of acceleration pickups need to be attached to and detached from an automobile door every time the welding state is inspected, and the configuration thereof is complicated.

In Patent Document 3, although a configuration aiming to maintain a constant impulsive force applied to the measurement target by using the elastic drive unit and the elastic movement restoring unit is disclosed, there is no specific disclosure or suggestion for inspecting the welding state of a strength component of a vehicle such as an automobile.

Particularly, when one hundred percent inspection is to be performed in a factory with respect to the welding state of the strength component of a vehicle such as an automobile, for example, a chassis component of the automobile having various specifications, non-destructive inspection of the welding state is required while satisfying both high efficiency and high accuracy. However, in the configurations of Patent Documents 1 to 3, there is no specific disclosure or suggestion for that.

Therefore, in the present circumstances, a novel configuration that enables accurate one hundred percent inspection to be performed in a factory with respect to the welding state of the strength components mass-produced in various specifications has been desired.

The present invention has been achieved to solve the above problems, and an object of the present invention is to provide a welding inspection device having a simple and compact configuration that enables accurate one hundred percent inspection in a factory with respect to the welding state of the strength components mass-produced in various specifications such as a chassis component of an automobile.

### Means for Solving the Problem

To achieve the above object, a first aspect of the present invention is to provide a welding inspection device comprising: an inspection unit that inspects a welding state of a press molded article formed by welding a first metal member and a second metal member, by using sound waves generated from the press molded article; an introduction unit provided on an upstream side in a conveyance, direction of the press molded article with respect to the inspection unit to introduce the press molded article toward the inspection unit; and a sorting unit provided on a downstream side in the conveyance direction with respect to the inspection unit to sort the press molded article fed out from the inspection unit according to the welding state of the press molded article inspected by the inspection unit, wherein the inspection unit includes a striking device having a striking member that applies an impulsive force to the press molded article, a drive mechanism that applies a drive force to the striking member so that the striking member applies the impulsive force to the press molded article, and an urging member that urges the striking member in a direction opposite to an application direction of the drive force by the drive mechanism, a microphone to which sound waves generated from the press molded article due to the impulsive force applied from the striking member is input, and a detection device that detects the welding state of the press molded article according to waveform characteristics of the sound waves input to the microphone, and the striking member applies the impulsive force to the press molded article in a state in which the drive force by the drive mechanism is cut off and the striking member is urged by the urging member in the direction opposite to the application direction, and after application of the impulsive force to the press molded article, the striking member is forcibly pulled back in the direction opposite to the application direction by the urging member.

According to a second aspect of the present invention, in addition to the first aspect, the inspection unit further includes a mounting member on which the press molded article is mounted, and the mounting member holds the press molded article only by a frictional force generated between the mounting member and the press molded article, in the application direction in which the striking member applies the impulsive force to the press molded article.

According to a third aspect of the present invention, in addition to the first or second aspect, the introduction unit includes a carry-in route member having an introduction route section inclined and extended so as to overhang the inspection unit for introducing the press molded article and an accumulation route section provided on the downstream side in the conveyance direction with respect to the introduction route section and extending in a vertical direction for accumulating the press molded articles, and a holding member that can freely advance and retract with respect to the press molded articles so that the press molded articles accumulated in the accumulation route section are dropped one by one to a lower part of the carry-in route member.

According to a fourth aspect of the present invention, in addition to any of the first to third aspects, a cooling unit that cools the press molded article is provided on the upstream side in the conveyance direction with respect to the introduction unit.

According to a fifth aspect of the present invention, in addition to any of the first to fourth aspects, a marking unit that marks the press molded article according to the welding state of the press molded article detected by the detection unit is provided between the inspection unit and the sorting unit.

According to a sixth aspect of the present invention, in addition to any of the first to fifth aspects, an imaging unit that detects a specification of the press molded article by imaging the press molded article is provided between the introduction unit and the detection unit.

According to a seventh aspect of the present invention, in addition to the sixth aspect, the introduction unit further includes a posture changing member that changes a posture of the press molded article with respect to the imaging unit.

According to an eight aspect of the present invention, in addition to the sixth or seventh aspect, the sorting unit includes an accumulation box with an arrangement position thereof being fixed, and a carry-out route member that can freely advance and retract with respect to an upper area of the accumulation box, and when the detection unit detects that the welding state of the press molded article is rejected, the carry-out route member can retract from the upper area of the accumulation box to open the upper area of the accumulation box and can freely drop the press molded article into the accumulation box or when the detection unit detects that the welding state of the press molded article is acceptable, the carry-out route member can advance into the upper area of the accumulation box to block the upper area of the accumulation box and can freely carry out the press molded article depending on the specification detected by the imaging unit.

According to a ninth aspect of the present invention, in addition to the eight aspect, the sorting unit further includes a guide member that can freely guide the press molded article to the accumulation box or to the carry-out route member.

### Effect of the Invention

According to the configuration of the first aspect of the present invention, the welding inspection device includes the inspection unit that inspects the welding state of the press molded article made of metal by using sound waves generated from the press molded article, the introduction unit provided on the upstream side in the conveyance direction of the press molded article with respect to the inspection unit to introduce the press molded article toward the inspection unit, and the sorting unit provided on the downstream side in the conveyance direction with respect to the inspection unit to sort the press molded article fed out from the inspection unit according to the welding state of the press molded article inspected by the inspection unit. The inspection unit includes the riking device having the striking member that applies the impulsive force to the press molded article, the drive mechanism that applies the drive force to the striking member so that the striking member applies the impulsive force to the press molded article, and the urging member that urges the striking member in the direction opposite to the application direction of the drive force by the drive mechanism, the microphone to which sound waves generated from the press molded article due to the impulsive force applied from the striking member is input, and the detection device that detects the welding state of the press molded article according to the waveform characteristics of the sound waves input to the microphone. The striking member applies the impulsive force to the press molded article in the state in which the drive force by the drive mechanism is cut off and the striking member is urged by the urging member in the direction opposite to the application direction, and after application of the impulsive force to the press molded article, the striking member is forcibly pulled back in the direction opposite to the application direction by the urging member. According to the configuration described above, while achieving the welding inspection device having a simple and compact configuration, one hundred percent inspection can be performed accurately in a factory with respect to the welding state of the press molded article, which is the strength component mass-produced in various specifications.

According to the configuration of the second aspect of the present invention, the inspection unit further includes the mounting member on which the press molded article is mounted, and the mounting member holds the press molded article only by the frictional force generated between the mounting member and the press molded article, in the application direction in which the striking member applies the impulsive force to the press molded article. Consequently, one hundred percent inspection can be performed accurately in a factory with respect to the welding state of the press molded articles mass-produced in various specifications.

According to the configuration of the third aspect of the present invention, the introduction unit includes the carry-in route member having the introduction route section inclined and extended so as to overhang the inspection unit for introducing the press molded article and the accumulation route section provided on the downstream side in the conveyance direction with respect to the introduction route section and extending in the vertical direction for accumulating the press molded articles, and the holding member that can freely advance and retract with respect to the press molded articles so that the press molded articles accumulated in the accumulation route section are dropped one by one to the lower part of the carry-in route member. Consequently, the total height and the total length of the welding inspection device can be decreased, and in a mode in which a load applied to the holding member is suppressed, one hundred percent inspection can be performed accurately in a factory with respect to the welding state of the press molded article, while feeding the press molded articles one by one to the inspection unit reliably.

According to the configuration of the fourth aspect of the present invention, the cooling unit that cools the press molded article is provided on the upstream side in the conveyance direction with respect to the introduction unit. Consequently, one hundred percent inspection can be performed accurately in a factory with high reproducibility with respect to the welding state of the press molded article, while feeding the press molded articles one by one reliably to the inspection unit.

According to the configuration of the fifth aspect of the present invention, the marking unit that marks the press molded article according to the welding state of the press molded article detected by the detection unit is provided between the inspection unit and the sorting unit. Consequently, the welding state of the press molded article can be visually confirmed, and inspection thereof can be performed more accurately.

According to the configuration of the sixth aspect of the present invention, the imaging unit that detects the specification of the press molded article by imaging the press molded article is provided between the introduction unit and the detection unit. Consequently, various specifications of the press molded article can be discriminated, and the inspection of the welding state can be performed more accurately corresponding to the specifications.

According to the configuration of the seventh aspect of the present invention, by providing the posture changing member that changes the posture of the press molded article with respect to the imaging unit, various specifications of the press molded article can be discriminated more accurately, and the inspection of the welding state can be performed more accurately corresponding to the specifications.

According to the configuration of the eighth aspect of the present invention, the sorting unit includes the accumulation box with the arrangement position thereof being fixed, and the carry-out route member that can freely advance and retract with respect to the upper area of the accumulation box. When the detection unit detects that the welding state of the press molded article is rejected, the carry-out route member can retract from the upper area of the accumulation box to open the upper area of the accumulation box and can freely drop the press molded article into the accumulation box, or when the detection unit detects that the welding state of the press molded article is acceptable, the carry-out route member can advance into the upper area of the accumulation box to block the upper area of the accumulation box and can freely carry out the press molded article depending on the specification detected by the imaging unit. Consequently, the press molded article detected that the welding state thereof is acceptable can be carried out to the outside reliably depending on the specification, while accumulating the press molded article detected that the welding state thereof is rejected reliably in the accumulation box.

According to the configuration of the ninth aspect of the present invention, the sorting unit further includes the guide member that can freely guide the press molded article to the accumulation box or to the carry-out route member. Consequently, the press molded article detected that the welding state thereof is acceptable can be carried out to the outside more reliably depending on the specification, while accumulating the press molded article detected that the welding state thereof is rejected more reliably in the accumulation box.

### BRIEF DESCRIPTION OF THE DRAWINGS

FIG. 1A is a schematic perspective view showing a configuration of a welding inspection device according to an embodiment of the present invention.

FIG. 1B is a schematic side view showing a configuration of a cooling unit of the welding inspection device according to the embodiment.

FIG. 2 is a partial cross-sectional diagram showing the configuration of the welding inspection device according to the embodiment, and corresponds to a partial cross-sectional diagram along line A-A in FIG. 1A.

FIG. 3A is a plan view including a partial cross-sectional diagram showing relevant parts of an inspection unit of the welding inspection device according to the embodiment, including a plan view showing a configuration of a press molded article mounted on the inspection unit, and corresponds to a view of a portion of the inspection unit in FIG. 2 as viewed from above.

FIG. 3B is a cross-sectional diagram corresponding to a partial cross-sectional diagram along line B-B in FIG. 3A.

FIG. 4 is a block diagram relating to an inspection control device of the welding inspection device according to the embodiment.

FIG. 5A is a partial cross-sectional diagram mainly showing an operation of an introduction unit of the welding inspection device according to the embodiment.

FIG. 5B is a partial cross-sectional diagram mainly showing the operation of the introduction unit of the welding inspection device according to the embodiment, and shows the next state of FIG. 5A time-sequentially.

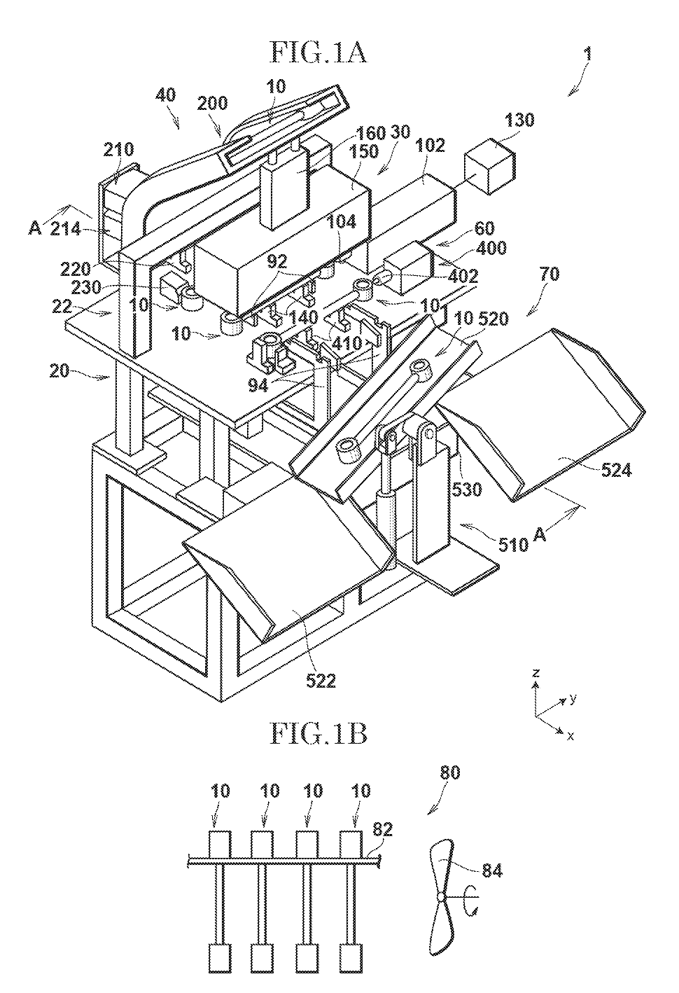

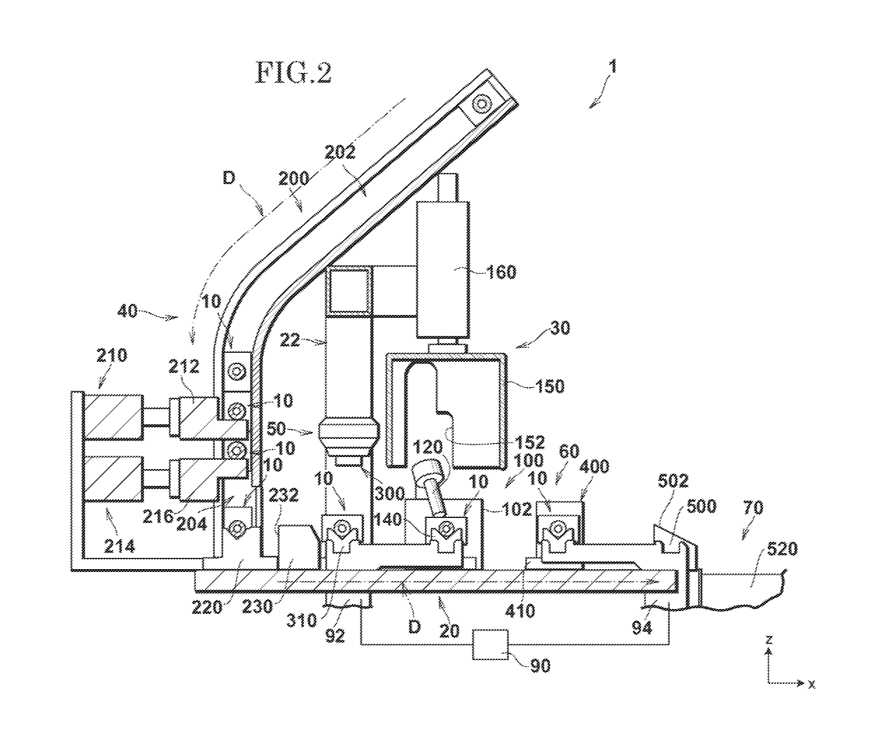

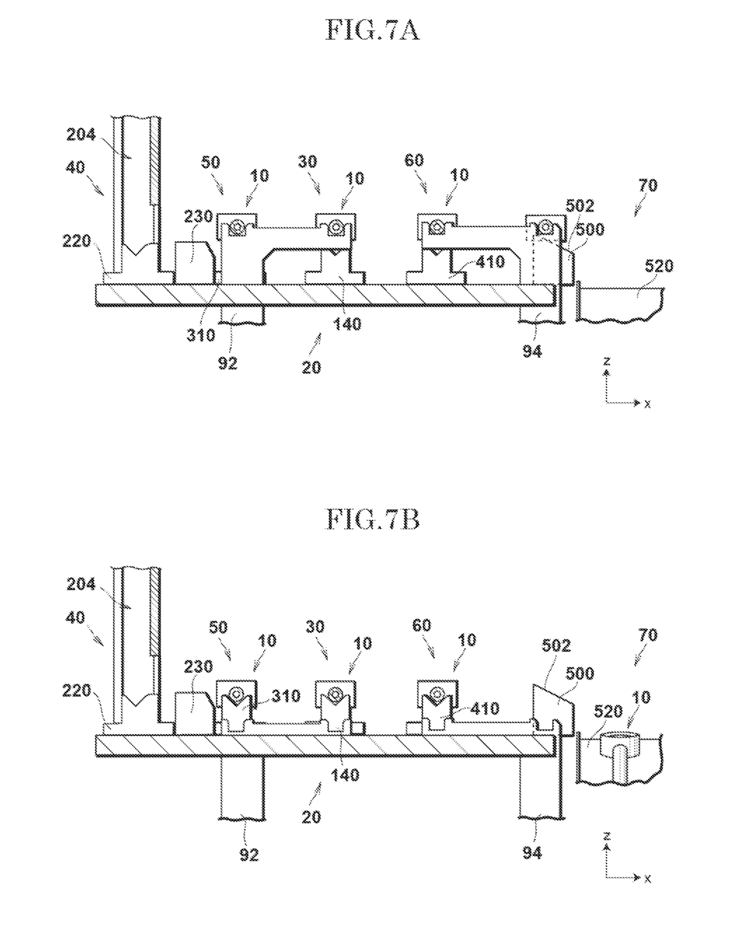

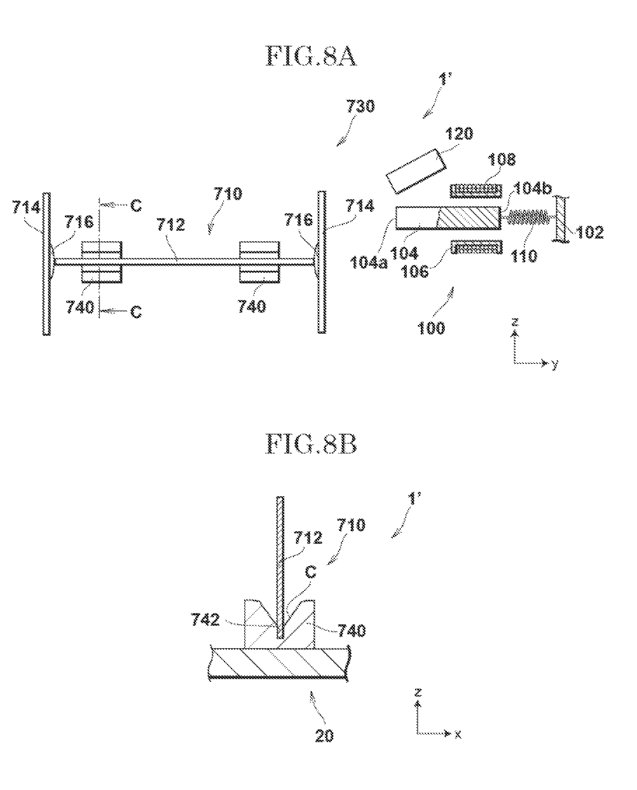

FIG. 1C is a partial cross-sectional diagram mainly showing the operation of the introduction unit of the welding inspection device according to the embodiment, and shows the next state of FIG. 5B time sequentially.

FIG. 6A is a partial cross-sectional diagram mainly showing an operation of constituent elements on the downstream side in the conveyance direction of the introduction unit of the welding inspection device according to the embodiment.

FIG. 6B is a partial cross-sectional diagram mainly showing the operation of the constituent elements on the downstream side in the conveyance direction of the introduction unit of the welding inspection device according to the embodiment, and shows the next state of FIG. 6A time-sequentially.

FIG. 6C is a partial cross-sectional diagram mainly showing the operation of the constituent elements on the downstream side in the conveyance direction of the introduction unit of the welding inspection device according to the embodiment, and shows the next state of FIG. 6B time-sequentially.

FIG. 7A is a partial cross-sectional diagram mainly showing the operation of the constituent elements on the downstream side in the conveyance direction of the introduction unit of the welding inspection device according to the embodiment, and shows the next state of FIG. 6C time-sequentially.

FIG. 7B is a partial cross-sectional diagram mainly showing the operation of the constituent elements on the downstream side in the conveyance direction of the introduction unit of the welding inspection device according to the embodiment, and shows the next state of FIG. 7A time-sequentially.

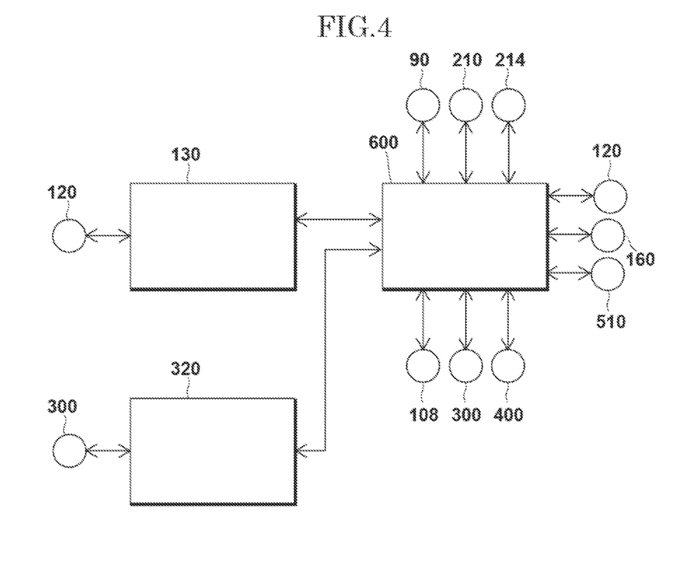

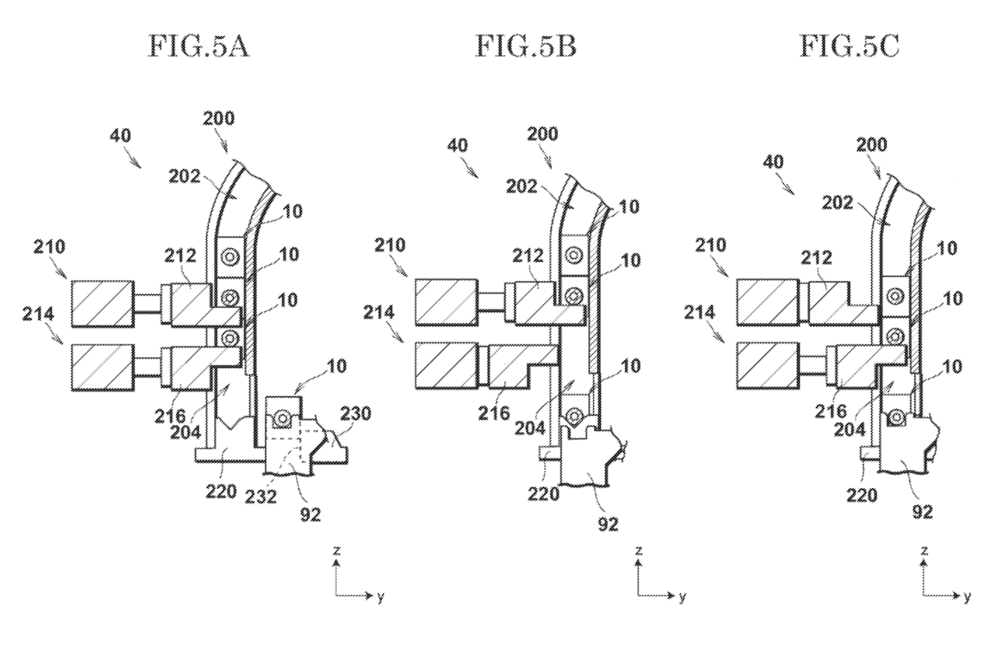

FIG. 8A is a plan view including a partial cross-sectional diagram showing relevant parts of an inspection unit of a welding inspection device in a modification of the embodiment, includes a plan view showing a configuration of a press molded article mounted on the inspection unit, and corresponds to FIG. 3A positionally.

FIG. 8B is a cross-sectional diagram corresponding to a partial cross-sectional diagram along line C-C in FIG. 8A.

### EMBODIMENT FOR CARRYING OUT THE INVENTION

A welding inspection device according to an embodiment of the present invention will be explained below in detail with reference to the accompanying drawings where appropriate. In the drawings, an x-axis, a y-axis, and a z-axis constitute a three-axis orthogonal coordinate system. It is assumed that a direction parallel to the z-axis is a vertical direction, and the positive direction of the z-axis is referred to as “upward”, and the negative direction of the z-axis is referred to as “downward”.

First, a configuration of a welding inspection device according to the present embodiment is explained in detail with reference to FIGS. 1 to 4.

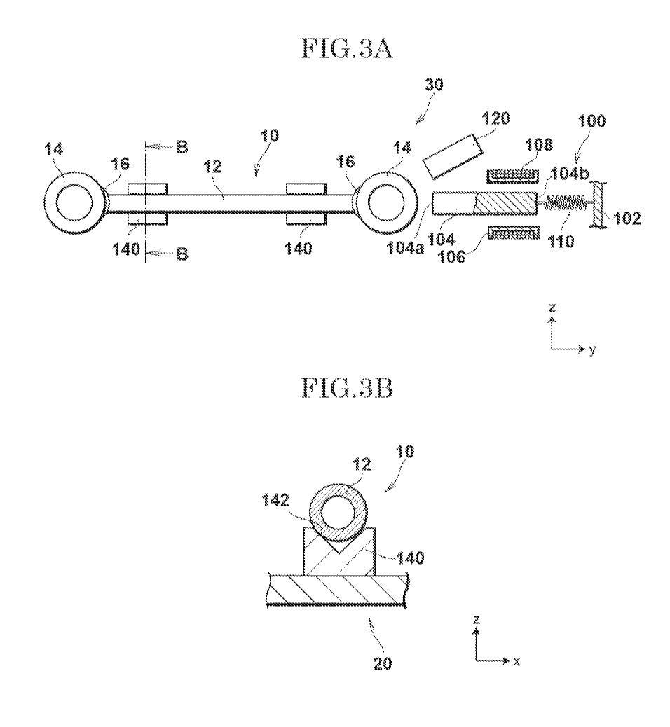

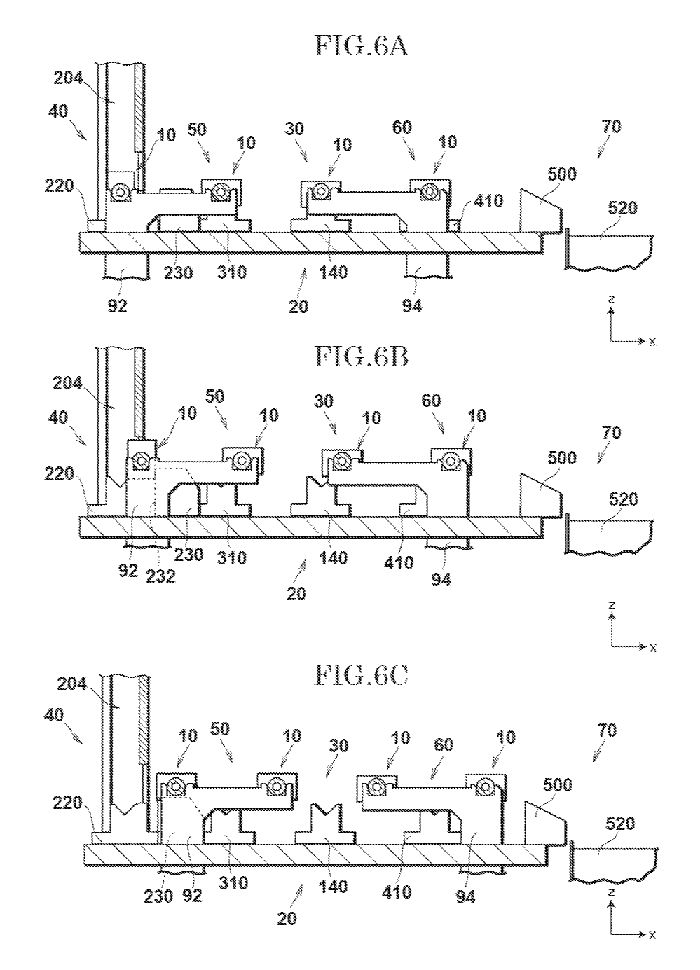

FIG. 1A is a schematic perspective view showing the configuration of the welding inspection device according to the present embodiment. FIG. 1B is a schematic side view showing a configuration of a cooling unit of the welding inspection device according to the present embodiment. FIG. 2 is a partial cross-sectional diagram showing the configuration of the welding inspection device according to the present embodiment, and corresponds to a partial cross-sectional diagram along line A-A in FIG. 1A. FIG. 3A is a plan view including a partial cross-sectional diagram showing relevant parts of an inspection unit of the welding inspection device according to the present embodiment, including a plan view showing a configuration of a press molded article mounted on the inspection unit, and corresponds to a view of a portion of the inspection unit in FIG. 2 as viewed from above. FIG. 3B corresponds to a partial cross-sectional diagram along line B-B in FIG. 3A. FIG. 4 is a block diagram relating to an inspection control device of the welding inspection device according to the present embodiment.

As shown in FIGS. 1 to 4, a welding inspection device 1 inspects the welding state of press molded articles 10 while sequentially conveying the press molded articles 10 along a conveyance direction D. The welding inspection device 1 includes an inspection unit 30 on a support table 20, and also includes an introduction unit 40 and an imaging unit 50 on an upstream side in the conveyance direction D with respect to the inspection unit 30. The welding inspection device 1 also includes a marking unit 60 and a sorting unit 70 on a downstream. side in the conveyance direction D with respect to the inspection unit 30. The introduction unit 40, the imaging unit 50, the inspection unit 30, the marking unit 60, and the sorting unit 70 are arranged in this order from the upstream side to the downstream side in the conveyance direction D. It is also desired that the welding inspection device 1 includes a cooling unit 80 on the upstream side in the conveyance direction D with respect to the introduction unit 40. The cooling unit 80 can be provided integrally with the introduction unit 40 or can be provided separately. The conveyance direction D of the press molded article 10 extends in the vertical direction, partially inclining in the introduction unit 40, extends in an x-axis direction in the imaging unit 50, the inspection unit 30, and the marking unit 60, and in the sorting unit 70, the conveyance direction D basically corresponds to a direction in which the press molded article 10 falls.

Specifically, the inspection unit 30 includes a case 102 fixedly provided on the support table 20 and a striking device 100 including an iron cylindrical striking member 104 supported by the case 102 so that the iron cylindrical striking member 104 can freely move relatively and one end 104a thereof is provided so as to protrude from the case 102 so that it can freely strike the press molded article 10 in a negative direction of the y-axis.

As the details of the press molded article 10 are specifically shown in FIGS. 3A and 3B, the press molded article 10 has such a configuration that collars 14 are fixedly provided on opposite ends of a rod 12, respectively, and each collar 14 is welded to the rod 12 in a welding portion 16. In the introduction unit 40, the imaging unit 50, the inspection unit 30, and the marking unit 50 of the welding inspection device 1, an extending axis of the rod 12 is aligned in a y-axis direction. The configuration of the press molded article 10 is not limited, and can be a configuration having an arbitrary number of welding portions at an arbitrary position and having a shape that can be conveyed by the welding inspection device 1. The configuration of the welding inspection device 1 can be appropriately adapted to exert similar functions according to the configuration of the press molded article 10. Further, the press molded article 10 can have various specifications corresponding to the place of destination or the like.

Specifically, the striking device 100 includes a resin bobbin 106 fixedly provided on the case 102 via a support member (not shown) and provided around the striking member 104, an excitation coil 108, which is an enameled wire mounted on the bobbin 106 and wound around the striking member 104, and a tension spring 110 suspended between the other end 104b of the striking member 104 and the case 102 to apply a tension force at all times to the striking member 104 in a positive direction of the y-axis. The excitation coil 108 wound around the bobbin 106 is a drive mechanism that drives the striking member 104 so that the one end 104a thereof strikes one collar 14 of the press molded article 10. The respective materials of the striking member 104, the bobbin 106, and the excitation coil 108 are not limited, and can be a combination of materials that can excite and drive the striking member 104 and have practically sufficient durability.

The drive force of the drive mechanism that drives the striking member 104 needs to be such that the drive force is once set to an application state with respect to the striking member 104 so that the one end 104a of the striking member 104 strikes one collar 14 of the press molded article 10, and thereafter, set to a non-application state with respect to the striking member 104 by quickly being cut off before the one end 104a abuts against the collar 14. The tension force that attempts to separate the striking member 104 from one collar 14 of the press molded article 10 is always applied to the striking member 104 by the tension spring 110. However, the initial position thereof is specified by a stopper (not shown) fixedly provided on the case 102. Accordingly, after the one end 104a of the striking member 104 strikes one collar 14 of the press molded article 10 once, the striking member 104 is away from the collar 14 without striking it again unnecessarily to come in contact with the stopper, and returns to the initial position. The drive force that drives the striking member 104 can be a drive force other than the excitation force, so long as the application state/non-application state can be switched quickly in such a short time.

The inspection unit 30 also includes a microphone 120 arranged near the collar 14 of the press molded article 10 to be struck by the striking member 104, to which sound waves generated from the press molded article 10 struck by the striking member 104 are input, and a sound-wave detection device 130 to which an electric signal output from the microphone 120 is input corresponding to the sound waves input to the microphone 120. The sound-wave detection device 130 has an arithmetic processing unit, a memory, and the like (not shown) incorporated therein, and typically, compares a waveform spectral pattern obtained from the electric signal input from the microphone 120 with a predetermined waveform spectral pattern stored in advance in the memory incorporated therein. By judging the degree of coincidence or the degree of approximation of a characteristic point such as a peak value thereof, a welding state of the welding portion 16 of the press molded article 10 can be freely detected. That is, the waveform spectral pattern of the electric signal input from the microphone 120 can be obtained by frequency analysis of the electric signal input from the microphone 120 at a predetermined time, and defined by a correspondence relation of a voltage value with respect to each predetermined frequency, so that the welding state of the welding portion 16 of the press molded article 10 can be reflected. When the press molded article 10 has various specifications, the predetermined waveform spectral pattern stored in advance in the memory is set corresponding to the various specifications.

The inspection unit 30 also includes two mounting members 140 fixedly provided on the support table 20 away from each other in the y-axis direction and can freely mount the rod 12 of the press molded article 10 correspondingly at the opposite ends thereof. The mounting member 140 includes a V-shaped inclined holding surface 142 in a cross section parallel to an x-z plane in order to put the rod 12 therebetween. The press molded article 10 comes in contact with only the inclined holding surface 142 of the mounting member 140 with respect to the side of the support table 20.

That is, the press molded article 10 is brought into contact with and supported only by the inclined holding surface 142 having the V shape in a cross section of the mounting member 140 in the rod 12. Accordingly, when the press molded article 10 is struck by the one end 104a of the striking member 104 in the negative direction of the y-axis, the press molded article 10 resists the impulsive force applied from the striking member 104 only by a static frictional force between the rod 12 and the inclined holding surface 142. Because the position of the press molded article 10 is not substantially moved, the press molded article 10 does not abut against remaining parts of the mounting member 140 unnecessarily to make noise such as interference sound. A contact surface of the mounting member 140 with respect to the press molded article 10 can be appropriately set so that a contact area can be sufficiently set corresponding to the shape of the rod 12. However, it is more preferable that the contact surface has a surface shape following the shape of the rod 12, for example, when the rod 12 has a cylindrical shape, a circumferential surface that abuts against the outer circumferential surface of the rod 12, so that the contact area can be increased to resist the impulsive force applied from the striking member 104 sufficiently.

The inspection unit 30 also includes a cover 150 provided movably in the vertical direction by a cover drive unit 160 fixedly provided on a support pillar 22. The cover 150 is dropped by the cover drive unit 160 to over the press molded article 10 when the striking member 104 strikes the press molded article 10. The cover 150 includes a cutout notch 152 for allowing the striking member 104 and the microphone 120 to escape so that the striking member 104 and the microphone 120 unnecessarily interfere with the cover 150 at that time.

The introduction unit 40 includes a route member 200 fixedly provided on the support table 20 to extend in the vertical direction, partially inclining so that the press molded article 10 can freely move inside of the route member 200 along the conveyance direction D. The route member 200 includes an introduction route section 202 inclined and extended so as to overhang the inspection unit 30 for sequentially introducing the press molded articles 10 from the upper end of the introduction route section 202, and an accumulation route section 204 continuously provided below the introduction route section 202 and extending in the vertical direction to accumulate the press molded articles 10 temporarily.

Here, corresponding to the accumulation route section 204, the introduction unit 40 also includes an upper holding member 212 driven in the x-axis direction so as to be able to advance and retract freely by an upper holding-member drive unit 210, a lower holding member 216 arranged below the upper holding member 212 and driven in the x-axis direction so as to be able to advance and retract freely by a lower holding-member drive unit 214, and two mounting members 270 fixedly provided on the support table 20 away from each other in the y-axis direction and can freely mount the rod 12 of the press molded article 10 correspondingly at the opposite ends thereof. The upper holding member 212 and the lower holding member 216 advance and retract in cooperation with each other to manipulate the position of the press molded article 10, so that the press molded articles 10 accumulated in the accumulation route section 204 can be dropped one by one to a lower part of the accumulation route section 204 under its own weight and can be freely mounted on the mounting member 220. At this time, because the introduction route section 202 is inclined and extended so as to overhang the inspection unit 30, a load to be applied to the upper holding member 212 due to the weight of the press molded articles 10 staying in the introduction route section 202 abutting against each other can be suppressed, while the height and the length of the entire welding inspection device 1 are reduced, and member strength required for the upper holding member 212 is suppressed. The upper holding-member drive unit 210 and the lower holding-member drive unit 214 are both fixedly provided on the support table 20.

The introduction unit 40 also includes two posture changing members 230 fixedly provided on the support table 20 away from each other in the y-axis direction on the downstream side in the conveyance direction D with respect to the mounting member 220. The posture changing members 230 can freely change the posture of the press molded article 10 so as to fit for imaging by the imaging unit 50 by causing the respective collars 14 of the press molded article 10 to abut against the vertical walls 232 of the posture changing members 230.

It is preferable to arrange the cooling unit 80 that can freely cool the temperature of the press molded article 10 in front of the route member 200 of the introduction unit 40, that is, on the upstream side in the conveyance direction D with respect to the introduction unit 40. The cooling unit 80 is configured to cool the press molded article 10 up to a low temperature of about several tens of degrees centigrade, taking into consideration that the collars 14 are respectively welded to the opposite ends of the rod 12 and become a high temperature of about several hundreds of degrees centigrade, before the press molded article 10 is introduced into the introduction unit 40. Typically, the cooling unit 80 includes a support member 82 that supports a plurality of press molded articles 10, and a fan 84 that can freely cool the press molded articles 10 forcibly. When the time required for cooling can be relatively long, the fan 84 can be omitted to cool the press molded articles 10 naturally, or when the time required for cooling is relatively short, a heat exchanger (not shown) that can forcibly cool the press molded articles 10 more powerfully can be arranged singly or in addition to the fan 84.

The reason why the cooling unit 80 is provided in front of the route member 200 of the introduction unit 40 to reduce the temperature of the press molded articles 10 up to about several tens of degrees centigrade is that frequency characteristics of sound waves generated from the press molded article 10 struck by the striking member 104 are stabilized and the welding state thereof can be detected accurately with high reproducibility. Further, the predetermined waveform spectral pattern stored in advance in the memory of the sound-wave detection device 130 is set corresponding to the temperature level.

The imaging unit 50 includes an imaging device 300, which is typically a digital still camera that can freely image an external form of the press molded article 10 conveyed, with the posture thereof changed by the posture changing member 230, with a required resolution as a still image, two mounting members 310 fixedly provided on the support table 20 away from each other in the y-axis direction and can freely mount the rod 12 of the press molded article 10 correspondingly at the opposite ends thereof, and an image detection device 320 having an arithmetic processing unit, a memory, and the like (not shown) incorporated therein, to which an electric signal output from the imaging device 300 is input. A holding member that regulates the axial direction of the press molded article 10 and holds the press molded article 10 can be provided in addition to the mounting member 310.

That is, the imaging device 300 images the press molded article 10 mounted on the mounting member 310, and transmits an electric signal, able to reflect information of the shape such as a profile shape of the press molded article 10, to the image detection device 320. The image detection device 320 extracts image information of the shape such as the profile shape of the press molded article 10 from the electric signal input from the imaging device 300 and compares the extracted image information with predetermined image information stored in advance in the memory incorporated therein, to judge the degree of coincidence or the degree of approximation of the characteristic point of the profile or the like, thereby enabling to detect various specifications of the press molded article 10 freely. At this time, the posture of the press molded article 10 mounted on the mounting member 310 has been changed to fit for imaging by the imaging device 300 by the posture changing member 230, so that the imaging device 300 can pick up the image of the shape such as the profile shape corresponding to the various specifications of the press molded article 10.

The marking unit 60 includes a marking drive unit 400 fixedly provided on the support table 20, a marking member 402 driven by the marking drive unit 400, and two mounting members 410 fixedly provided on the support table 20 away from each other in the y-axis direction and can freely mount the rod 12 of the press molded article 10 correspondingly at the opposite ends thereof. A holding member that regulates the axial direction of the press molded article 10 and holds the press molded article 10 can be provided in addition to the mounting member 410.

The marking drive unit 400 drives the marking member 402 corresponding to the welding state of the welding portion 16 of the press molded article 10 detected by the sound-wave detection device 130. The marking member 402 applies marking to one of the collars 14 of the press molded article 10 according to the driven state thereof. The marking applied by the marking member 402 is typically electric discharge marking corresponding to acceptance/rejection of the welding state of the welding portion 16. The marking applied by the marking member 402 can also be performed according to only the specification of the press molded article 10 detected by the image detection device 320 or according to the specification in combination with acceptance/rejection of the welding state of the welding portion 16, and the method thereof can be ink jet marking other than the electric discharge marking.

The sorting unit 70 includes two guide members 500 fixedly provided on the support table 20 away from each other in the y-axis direction on the downstream side in the conveyance direction D with respect to the mounting member 410, a carry-out drive mechanism 510 fixedly provided on the support table 20, a first carry-out route member 520, a second carry-out route member 522, and a third carry-out route member 524 respectively driven by the carry-out drive mechanism 510, and an accumulation box 530 that temporarily accumulates the press molded articles 10, for which it is detected that the welding state of the welding portion 16 is rejected. The guide member 500 can freely guide the press molded article 10 to the first carry-out route member 520 or to the accumulation box 530 by causing the rod 12 of the press molded article 10 to slide down on an inclined guide surface 502 in sliding contact therewith. The accumulation box 530 is fixed and arranged close to the guide member 500 in the x-axis direction than the second carry-out route member 522 and the third carry-out route member 524.

When it is detected that the welding state of the welding portion 16 of the press molded article 10 is rejected, the carry-out drive mechanism 510 moves the first. carry-out route member 520 in a positive direction of the x-axis to open an upper area of the accumulation box 530. Corresponding thereto, after the rod 12 has slid down on the inclined guide surface 502, the press molded article 10 falls down between the second carry-out route member 522 and the third carry-out route member 524 under its own weight, and can freely fall into the accumulation box 530 eventually.

On the other hand, when it is detected that the welding state of the welding portion 16 of the press molded article 10 is acceptable, the carry out drive mechanism 510 causes the first carry-out route member 520 to move in a negative direction of the x-axis, and rotate and incline depending on the specification of the press molded article 10 detected by the image detection device 320. Corresponding thereto, after the rod 12 has slid down on the inclined guide surface 502, the press molded article 10 slides down along the upper surface of the first carry-out route member 520 under its own weight and is guided to one of the second carry-out route member 522 and the third carry-out route member 524 depending on the specification, continuously slides down on the upper surface thereof, and can be freely carried out to the outside of the welding inspection device 1. The carried-out press molded article 10 is fed to a painting process on the subsequent stage.

The welding inspection device 1 also includes a conveyance drive unit 90 fixedly provided on the support table 20, and an upstream-side conveyance member 92 and a downstream-side conveyance member 94 respectively driven by the conveyance drive unit 90. The upstream-side conveyance member 92 and the downstream side conveyance member 94 are provided in a pair facing each other in the y-axis direction to convey the press molded article 10 in a state in which the opposite ends of the rod 12 of the press molded article 10 are mounted on concave portions respectively provided therein.

More specifically, the upstream-side conveyance member 92 is driven by the conveyance drive unit 90 to convey the press molded article 10 from the introduction unit 40 to the imaging unit 50 along the conveyance direction D, that is, from a state of being mounted on the mounting member 220 to a state of being mounted on the mounting member 310 via the posture changing member 230, and convey the press molded article 10 from the imaging unit 50 to the inspection unit 30 along the conveyance direction D, that is, from a state of being mounted on the mounting member 310 to a state of being mounted on the mounting member 140.

Further, the downstream-side conveyance member 94 is driven by the conveyance drive unit 90 to convey the press molded article 10 from the inspection unit 30 to the marking unit 60 along the conveyance direction D, that is, from a state of being mounted on the mounting member 140 to a state of being mounted on the mounting member 410, and convey the press molded article 10 from the marking unit 60 to the sorting unit 70 along the conveyance direction D, that is, from a state of being mounted on the mounting member 410 to a state of being mounted on the inclined guide surface 502 of the guide member 500.

Further, as shown in FIG. 4, the welding inspection device 1 also includes an inspection control device 600 that controls the operation of constituent elements of the welding inspection device 1.

More specifically, the inspection control device 600 has an arithmetic processing unit, a memory, and the like (not shown) incorporated therein, to which an electric signal that carries a detection result obtained by detecting the welding state of the welding portion 16 of the press molded article 10 can be freely input from the sound-wave detection device 130 connected to the microphone 120, and an electric signal that carries a detection result obtained by detecting the specification of the press molded article 10 can be freely input from the image detection device 320 connected to the imaging device 300.

Further, the inspection control device 600 can drive and control the conveyance drive unit 90, the excitation coil. 100 of the striking device 100, the microphone 120, the cover drive unit 160, the upper holding-member drive unit 210, the lower holding-member drive unit 214, the imaging device 300, the marking drive unit 400, and the carry-out drive mechanism 510 appropriately based on the detection result of the welding state of the welding portion 16 of the press molded article 10 and the detection result of the specification of the press molded article 10 or at a required timing. The inspection control device 600 and the related devices are connected to a power source (not shown).

The operation of the welding inspection device 1 having the configuration described above is explained in detail with reference also to FIGS. 5 to 7.

FIG. 5 is a partial cross-sectional diagram mainly showing an operation of an introduction unit of the welding inspection device according to the present embodiment, and shows the operation from FIGS. 5A to 5C in time-sequential. FIGS. 6 and 7 are partial cross-sectional diagrams mainly showing an operation of constituent elements arranged on the downstream side in the conveyance direction of the introduction unit in the welding inspection device according to the present embodiment, and show the operation from FIGS. 1A to 7B in time-sequential.

The conveyance operation of the introduction unit 40 is explained first. As shown in FIG. 5A, in the route member 200, the press molded articles 10 sequentially introduced from the upper end of the introduction route section 202 reach the accumulation route section 204 continuously provided below the introduction route section 202. At this time, the press molded article 10 positioned in a lower part of the accumulation route section 204 is separated so as not to abut against the upper press molded article 10 and the rod 12 thereof is supported by the lower holding member 216 driven in the positive direction of the x-axis by the lower holding-member drive unit 214 and entered into the accumulation route section 204.

Meanwhile, the rod 12 of the upper press molded article 10 is supported by the upper holding member 212 driven in the positive direction of the x-axis by the upper holding-member drive unit 210 and entered into the accumulation route section 204. Regarding the press molded article 10 supported by the upper holding member 212 and the press molded articles 10 positioned on the upstream side thereof in the conveyance direction, the collars 14 of the adjacent press molded articles abut against each other, and thus weights thereof are applied to the upper holding member 212. However, because the introduction route section 202 is inclined and extended so as to overhang the inspection unit 30, a part of the weights is received by the introduction route section 202, and corresponding thereto, a load applied to the upper holding member 212 is reduced. That is, because the strength required for the upper holding member 212 is reduced, the weight and size thereof are reduced.

The press molded article 10 mounted on the mounting member 220 arranged at the lowest position in the accumulation route section 204 starts to be conveyed toward the imaging unit 50 by the upstream-side conveyance member 92. At this time, the collar 14 of the press molded article 10 abuts against the vertical wall 232 of the posture changing member 230, and the posture of the press molded article 10 starts to be changed to fit for imaging by the imaging unit 50.

As shown in FIG. 5B, when the lower holding-member drive unit 214 drives the lower holding member 216 in the negative direction of the x-axis so as to move out of the accumulation route section 204, the press molded article 10 supported by the lower holding member 215 is released therefrom, and falls down onto the mounting member 220 arranged on the lower side thereof under its own weight and is mounted thereon. Meanwhile, the upper press molded article 10 on the upper side is continuously supported by the upper holding member 212 driven by the upper holding-member drive unit 210 in the positive direction of the x-axis and entered into the accumulation route section 204. The upstream-side conveyance member 92 then approaches the press molded article 10 mounted on the mounting member 220 arranged at the lowest position of the accumulation route section 204.

Subsequently, as shown in FIG. 5C, when the upper holding-member drive unit 210 drives the upper holding member 212 in the negative direction of the x-axis so as to move out of the accumulation route section 204, and the lower holding-member drive unit 214 drives the lower holding member 216 in the positive direction of the x-axis so as to enter into the accumulation route section 204, the press molded article 10 supported by the upper holding member 212 is released and falls down onto the lower holding member 216 under its own weight and is held thereon. The press molded article 10 mounted on the mounting member 220 arranged at the lowest position of the accumulation route section 204 is held by the upstream-side conveyance member 92 and starts to be conveyed toward the imaging unit 50.

That is, the introduction unit 40 sequentially repeats the operation described above. Before the press molded article 10 is introduced into the introduction unit 40, the temperature thereof is decreased to a predetermined level of several tens of degrees centigrade by the cooling unit 80.

A conveyance operation of the constituent elements on the downstream side in the conveyance direction D of the introduction unit 40 is explained further. As shown in FIG. 6A, the upstream-side conveyance member 92 holds the press molded article 10 mounted on the mounting member 220 and the press molded article 10 mounted on the mounting member 310, respectively. Subsequently, as shown in FIG. 6B, the upstream-side conveyance member 92 starts to convey the press molded articles 10 to the downstream side in the conveyance direction D toward the corresponding imaging unit 50 and inspection unit 30, and then, approaches the corresponding imaging unit 50 and inspection unit 30, as shown in FIG. 6C. In the state shown in FIG. 6B, the collar 14 of the press molded article 10 abuts the vertical wall 232 of the posture changing member 230. In the state shown in FIG. 6C, the press molded article 10 rotates, and the posture thereof is changed in a horizontal direction so as to fit for imaging by the imaging unit 50.

Meanwhile, at first, as shown in FIG. 6A, the downstream-side conveyance member 94 holds the press molded article 10 mounted on the mounting member 140 and the press molded article 10 mounted on the mounting member 410, respectively. Subsequently, as shown in FIG. 6B, the downstream-side conveyance member 94 starts to convey the press molded articles 10 to the downstream side in the conveyance direction D toward the corresponding marking unit 60 and sorting unit 70, and then, approaches the corresponding marking unit 60 and sorting unit 70, as shown in FIG. 6C.

Next, as shown in FIG. 7A, the upstream-side conveyance member 92 positions the press molded articles 10 respectively above the corresponding imaging unit 50 and inspection unit 30, and as shown in FIG. 7B, mounts the press molded articles 10 on the corresponding mounting members 310 and 140 and returns to the upstream side in the conveyance direction D.

In the imaging unit 50, the imaging device 300 images the press molded article 10 mounted on the mounting member 310 according to a control signal input from the inspection control device 600, and transmits an electric signal that carries information of the shape of the press molded article 10 to the image detection device 320. The image detection device 320 extracts the image information of the shape such as the profile shape of the press molded article 10 from the electric signal input from the imaging device 300, and compares the extracted image information with the predetermined image information stored in advance in the memory incorporated therein, to judge the degree of coincidence or the degree of approximation of the characteristic point of the profile or the like, thereby detecting various specifications of the press molded article 10. The image detection device 320 also transmits the electric signal that carries the detected specification of the press molded article 10 to the inspection control device 600.

The inspection unit 30 covers the press molded article 10 with the cover 150 according to the control signal input from the inspection control device 600. The striking member 104 moves from the initial position toward the collar 14 of the press molded article 10 opposite thereto due to excitation of the excitation coil 108 of the striking device 100 against the tension force of the tension spring 110 to strike the collar 14 and apply the impulsive force. Thereafter, the striking member 104 is forcibly pulled back to the initial position by the tension force of the tension spring 110. After the excitation coil 108 is once set to an excitation state in this manner, the excitation coil 108 is set to a non-excitation state by cutting off the drive power quickly before the one end 104a of the striking member 104 abuts against the collar 14 of the press molded article 10 opposite thereto. Therefore, when the one end 104a of the striking member 104 strikes the collar 14 of the press molded article 10 opposite thereto, or is pulled back by the tension force of the tension spring 110 thereafter, only the tension force of the tension spring 110 is applied to the striking member 104.

Furthermore, in the inspection unit 30, the rod 12 of the press molded article 10 is brought into contact with and supported only by the inclined holding surface 142 having the V-shape in the cross section of the mounting member 140. Therefore, when the striking member 104 strikes the collar 14 of the press molded article 10 opposite thereto to apply the impulsive force, the press molded article 10 is supported on the mounting member 140 against the impulsive force applied from the striking member 104 only by the static frictional force between the rod 12 and the inclined holding surface 142, and does not abut against remaining parts of the mounting member 140 unnecessarily to make noise such as interference sound.

Simultaneously, in the inspection unit 30, according to the control signal input from the inspection control device 600, the microphone 120 receives sound waves generated from the press molded article 10 due to application of the impulsive force by the striking member 104 by striking the collar 14 of the press molded article 10 opposite thereto, transmits an electric signal corresponding thereto to the sound-wave detection device 130. Corresponding thereto, the sound-wave detection device 130 compares the waveform spectral pattern obtained from the electric signal input from the microphone 120 with a reference waveform spectral pattern stored in advance in the memory incorporated therein, to judge the degree of coincidence or the degree of approximation of the characteristic point such as a peak value thereof, thereby detecting the welding state of the welding portion 16 of the press molded article 10. A control signal carrying the specification information of the press molded article 10 is input from the inspection control device 600 to the sound-wave detection device 130, and the sound-wave detection device 130 selects the reference waveform spectral pattern corresponding to the specification information. The welding state of the welding portion 16 of the press molded article 10 detected by the sound-wave detection device 130 is transmitted as an electric signal carrying the information from the sound-wave detection device 130 to the inspection control device 600.

Meanwhile, as shown in FIG. 7A, the downstream-side conveyance member 94 positions the press molded article 10 above the marking unit 60, and positions the press: molded article 10 above the inclined guide surface 502 of the guide member 500. Subsequently, as shown in FIG. 7B, the downstream-side conveyance member 94 mounts the press molded article 10 on the. mounting member 410 of the marking unit 60, and after feeding the press molded article 10 to the sorting unit 70 through the inclined guide surface 502 of the guide member 500, the downstream-side conveyance member 94 returns to the upstream side in the conveyance direction D. In FIG. 7B, for convenience sake, the press molded article 10 introduced into the sorting unit 70 is shown in a state of being guided to the first carry-out route member 520.

In the marking unit 60, according to the control signal input from the inspection control device 600, the marking drive unit 400 drives the marking member 402 corresponding to the welding state of the welding portion 16 of the press molded article 10 carried in the control signal input from the inspection control device 600. The marking member 402 applies marking to one of the collars 14 of the press molded article 10 according to the driven state thereof. The marking applied by the marking member 402 can also be performed according to only the specification of the press molded article 10 detected by the image detection device 320 or according to the specification in combination with acceptance/rejection of the welding state of the welding portion 16.

In the sorting unit 70, according to the control signal input from the inspection control device 600, the carry-out drive mechanism 510 moves the first carry-out route member 520 corresponding to the welding state of the welding portion 16 of the press molded article 10 carried in the control signal input from the inspection control device 500.

Specifically, when it is detected that the welding state of the welding portion 16 of the press molded article 10 is rejected, the carry-out drive mechanism 510 moves the first carry-out route member 520 in the positive direction of the x-axis to open the upper area of the accumulation box 530. Corresponding thereto, after the rod 12 of the press molded article 10 has slid down on the inclined guide surface 502, the press molded article 10 falls down between the second carry-out route member 522 and the third carry-out route member 524 under its own weight and eventually falls into the accumulation box 530 and accumulated therein. On the other hand, when it is detected that the welding state of the welding portion 16 of the press molded article 10 is acceptable, the carry-out drive mechanism 510 causes the first carry-out route member 520 to move in a negative direction of the x-axis, and rotate and incline depending on the specification of the press molded article 10 detected by the image detection device 320. Corresponding thereto, after the rod 12 has slid down on the inclined guide surface 502, the press molded article 10 slides down along the upper surface of the first carry-out route member 520 under its own weight and is guided to one of the second carry-out route member 522 and the third carry-out route member 524 depending on the specification, continuously slides down on the upper surface thereof, is carried to the outside of the welding inspection device 1, and is fed to the painting process in the subsequent stage.

The welding inspection device 1 then sequentially repeats the respective, processes described above, such as introduction of the press molded. article 10, discrimination of the specification, inspection of the welding state, and sorting.

The press molded article 10 according to the present embodiment has a configuration in which the collars 14 are fixedly provided on the opposite ends of the rod 12, respectively, and each collar 14 is welded to the rod 12 in the welding portion 16. In principle, it suffices that the press molded article has an arbitrary number of welding portions at an arbitrary position and has a shape or the like that can be freely conveyed by the welding inspection device 1. Corresponding thereto, the detailed configuration of the welding inspection device 1 can be appropriately adapted to exert similar functions. A modification of the present embodiment configured by welding tabular members is explained further in detail with reference also to FIGS. 8A. and 8B as

FIG. 8A is a plan view including a partial cross-sectional diagram showing relevant parts of an inspection unit of a welding inspection device in the modification of the present embodiment, and includes a plan view showing a configuration of a press molded article mounted on the inspection unit, and FIG. 8A corresponds to FIG. 3A positionally. FIG. 8B is a cross-sectional diagram corresponding to a partial cross-sectional diagram along line C-C in FIG. 8A.

As shown in detail in FIGS. 8A and 8B, a press molded article 710 of the present modification is configured with a plurality of tabular members, and corresponding thereto, the detailed configuration of a welding inspection device 1′ of the present modification is changed, which is a main different point from that of the present embodiment. Remaining configurations are the same as those of the above embodiment. In the present modification, the different points from the above embodiment are mainly explained, and like reference characters refer to like constituent elements and explanations thereof will be simplified or omitted as appropriate.

Specifically, the press molded article 710 has such a configuration that end tabular members 714 are fixedly provided on opposite ends of a central tabular member 712, respectively, and each end tabular member 714 is welded to the central tabular member 712 in a welding portion 716.

Furthermore, corresponding to the configuration of the press molded article 710, the striking member 104 of the striking device 100 in an inspection unit 730 is arranged to strike a part of one of the end tabular members 714. The position at which the striking member 104 strikes one of the end tabular members 714 can be a position corresponding to the welding portion 716, or can be a position deviated from the welding portion 716. In FIG. 8A, a configuration example in which the striking member 104 strikes one of the end tabular members 714 at a position deviated from the welding portion 716 is shown.

Further, corresponding to the configuration of the press molded article 710, the inspection unit 730 includes two mounting members 740 fixedly provided on the support table 20 away from each other in the y-axis direction and can freely mount the central tabular member 712 of the press molded article 710 correspondingly at the opposite ends thereof. The mounting member 740 has a rectangular concave surface 742 in the cross section parallel to the plane in order to put the central tabular member 712 therebetween, and the press molded article 710 comes in contact with only the concave surface 742 of the mounting member 740 with respect to the side of the support table 20.

That is, the press molded article 710 is brought into contact with and supported only by the concave surface 742 having the rectangular shape in the cross section of the mounting member 740 in the central tabular member 712. Accordingly, when the press molded article 710 is struck by the one end 104a of the striking member 104 in the negative direction of the y-axis, the press molded article 710 resists the impulsive force applied from the striking member 104 only by a static frictional force between the central tabular member 712 and the concave surface 742. Because the position of the press molded article 710 is not substantially changed, the press molded article 710 does not abut against remaining parts of the mounting member 740 unnecessarily to make noise such as interference sound. The depth in the z direction of the concave surface 742, which is a contact surface of the mounting member 740 with respect to the press molded article 710, can be freely adjusted by providing an upper cutout C in the mounting member 740, and corresponding thereto, a contact area thereof can be freely adjusted.

In the configuration described above, the press molded article 10 has a configuration of combining the rod 12 and the collar 14, and the press molded article 710 has a configuration of combining the tabular members 712 and 714. These can be appropriately combined selectively, or other members having a different shape can be further combined according to need. That is, the configuration of such a press molded article is not limited, and it suffices that the press molded article has a configuration having an arbitrary number of welding portions at an arbitrary position and having a shape that can be freely conveyed by the welding inspection device in the present invention. The configuration of such a welding inspection device can be appropriately adapted to exert similar functions according to the configuration of the press molded article.

### INDUSTRIAL APPLICABILITY

In the present invention, the shapes, arrangements, and number of members are not limited to those described in the above embodiments, and it is needless to mention that changes can be appropriately made without departing from the scope of the invention, such as replacing these constituent elements with other elements having equivalent operational effects.

As described above, the present invention can provide a welding inspection device having a simple and compact configuration that enables one hundred percent inspection in a factory with respect to a welding state of a strength component of a vehicle such as an automobile, for example, a chassis component of the automobile having various specifications. Therefore, because of its general purposes and universal characteristics, applications of the present invention are expected in a wide range in the field of a welding inspection of constituent elements of a movable body such as an automobile.

1. A welding inspection device comprising:
an inspection unit that inspects a welding state of a press molded article formed by welding a first metal member and a second metal member, by using sound waves generated from the press molded article;
an introduction unit provided on an upstream side in a conveyance direction of the press molded article with respect to the inspection unit to introduce the press molded article toward the inspection unit; and
a soiling unit provided on a downstream side in the conveyance direction with respect to the inspection unit to sort the press molded article fed out from the inspection unit according to the welding state of the press molded article inspected by the inspection unit, wherein the inspection unit includes a striking device having a striking member that applies an impulsive force to the press molded article, a drive mechanism that applies a drive force to the striking member so that the striking member applies the impulsive force to the press molded article, and an urging member that urges the striking member in a direction opposite to an application direction of the drive force by the drive mechanism, a microphone to which sound waves generated from the press molded article due to the impulsive force applied from the striking member is input, and a detection device that detects the welding state of the press molded article according to waveform characteristics of the sound waves input to the microphone, and
the striking member applies the impulsive force to the press molded article in a state in which the drive force by the drive mechanism is cut off and the striking member is urged by the urging member in the direction opposite to the application direction, and after application of the impulsive force to the press molded article, the striking member is forcibly pulled hack in the direction opposite to the application direction by the urging member.

2. The welding inspection device according to claim 1, wherein the inspection unit further includes a mounting member on winch the press molded article is mounted, and the mounting member holds the press molded article only by a frictional force generated between the mounting member and the press molded article, in the application direction in which the striking member applies the impulsive force to the press molded article.

3. The welding inspection device according to claim 1, wherein the introduction unit includes a carry-in route member having an introduction route section inclined and extended so as to overhang the inspection unit for introducing the press molded article and an accumulation route section provided on the downstream side in the conveyance direction with respect to the introduction route section and extending in a vertical direction for accumulating the press molded articles, and a holding member that can freely advance and retract with respect to the press molded articles so that the press molded articles accumulated in the accumulation route section are dropped one by one to a lower part of the carry-in route member.

4. The welding inspection device according to claim 1, wherein a cooling unit that cools the press molded article is provided on the upstream side in the conveyance direction with respect to the introduction unit.

5. The welding inspection device according to claim 1, wherein a marking unit that marks the press molded article according to the welding state of the press molded article detected by the detection unit is provided between the inspection unit and the sorting unit.

6. The welding inspection device according to claim 1, wherein an imaging unit that detects a specification of the press molded article by imaging the press molded article is provided between the introduction unit and the detection unit.

7. The welding inspection device according to claim 6, wherein the introduction unit further includes a posture changing member that changes a posture of the press molded article with respect to the imaging unit.

8. The welding inspection device according to claim 6, wherein the sorting unit includes an accumulation box with an arrangement position thereof being fixed, and a carry-out route member that can freely advance and retract with respect to an upper area of the accumulation box, and When the detection unit detects that the welding state of the press molded article is rejected, the carry-out route member can retract from the upper area of the accumulation box to open the upper area of the accumulation box and can freely drop the press molded article into the accumulation box of when the detection unit detects that the welding state of the press molded article is acceptable, the carry-out route member can advance into the upper area of the accumulation box to block the upper area of the accumulation box and can freely carry out the press molded article depending on the specification detected by the imaging unit.

9. The welding inspection device according to claim 8, wherein the sorting unit further includes a guide member that can freely guide the press molded article to the accumulation box or to the carry-out route member.

10. The welding inspection device according to claim 2, wherein the introduction unit includes a carry-in route member having an introduction route section inclined and extended so as to overhang the inspection unit for introducing the press molded article and an accumulation route section provided on the downstream side in the conveyance direction with respect to the introduction route section and extending in a vertical direction for accumulating the press molded articles, and a holding member that can freely advance and retract with respect to the press molded articles so that the press molded articles accumulated in the accumulation route section are dropped one by one to a lower part of the carry-in route member.
